(19) United States
(12) Patent Application Publication
(10) Pub. No.: US 2026/0328028 A1
(43) Pub. Date: Oct. 22, 2026

(54) DEVICE FOR DRIVING A DOOR HANDLE

(71) Applicant: Kiekert Aktiengesellschaft, Heiligenhaus (DE)

(72) Inventor: Benjamin DJEDOVIC, Oberhausen (DE)

(73) Assignee: Kiekert Aktiengesellschaft, Heiligenhaus (DE)

(21) Appl. No.: 19/105,971

(22) PCT Filed: Sep. 6, 2023
(86) PCT No.: PCT/DE2023/100655

§ 371 Date: Feb. 24, 2025

(30) Foreign Application Priority Data
Sep. 12, 2022 (DE) 10 2022 123 131.3

(51) Int. Cl. E05B 85/10; E05B 81/06; E05B 81/34; E05B 81/64

(52) U.S. Cl. CPC E05B 85/107; E05B 81/06; E05B 81/34; E05B 81/64; E05B 85/103

(57) ABSTRACT

A device for driving a door handle of a motor vehicle in order to move the door handle from a first position, in particular a rest position, into a second position, in particular an actuating position, said device comprising: an electric drive; a gearbox connected downstream of the electric drive; and an output gear associated with the gearbox, it being possible to introduce a movement into the door handle by means of the output gear, and a means for position detection being associated with at least one gearbox part.

The invention relates to a device for driving a door handle of a motor vehicle, to move the door handle from a first position, in particular a rest position, into a second position, in particular an actuating position, having an electric drive, a gearbox connected downstream of the electric drive, and a drive gear associated with the gearbox, wherein a movement can be introduced into the door handle by means of the drive gear.

One of the aims of automobile manufacturers is to optimize the aerodynamics of vehicles and to achieve as little air resistance as possible on the vehicle. A door handle on a vehicle has a negative influence on a linear flow if it protrudes from the door. In addition to the aerodynamic disadvantages of a protruding door handle, the design of the motor vehicle is also influenced by a door handle protruding from the vehicle.

To overcome these disadvantages, solutions have become known in which the door handle is flush with the surface of the vehicle, and in particular the side door. For example, DE 10 2015 115 673 A1 discloses a flush-mounted outside door handle, wherein the outside door handle can be moved out of the door surface by means of a corresponding mechanism. In other words, the door handle can be moved back and forth between two different positions. Starting from a flush first position, the door handle can be moved by means of a mechanism into a second position in which the outside door handle protrudes from the door surface. In this second position, the outside door handle can be grasped by the operator, and the door can be opened. For moving the outside door handle, a comprehensive mechanism is disclosed, which moves the outside door handle electrically.

The generic prior art is represented by DE 10 216 113 167 A1. The document discloses a device for driving a door handle of a motor vehicle, for moving the door handle from a first position, in particular a rest position, into a second position, in particular an actuating position, having an electric drive, a gearbox downstream of the electric drive, and an output gear associated with the gearbox, wherein a movement can be introduced into the door handle by means of the output gear. The first position of the door handle is the position, which can also be referred to as the starting position, in which the door handle is flush with the outer skin of the body, and preferably the side door. The second position refers to a position of the door handle after the door handle has performed a translational movement and protrudes from the body of the motor vehicle. In this extended position, the operator is able to operate the door handle and unlock a vehicle lock. The translational movement is carried out by means of an output gear and in cooperation with a toothed rack arranged on the door handle.

The drives known from the prior art for a door handle are generally in need of improvement. On the one hand, the prior art features a complex mechanism, which in turn appears to be susceptible to failure and particularly vulnerable to external weather influences, and on the other, a simple electric drive with motor and gearbox cannot guarantee reliable operation, especially in the event of a power failure. In particular, in the event of a power failure, the door handle must be returned to its original position, wherein the door handle must be moved out of the non-powered position. The disadvantage in this case is that the position of the door handle cannot be clearly determined, and the mechanism is subjected to great stress when it is forced against a stop. This is where the invention comes in.

The object of the invention is to provide an improved device for driving a door handle of a motor vehicle, which overcomes the disadvantages of the prior art. Furthermore, it is an object of the invention to enable reliable movement of the door handle without placing excessive strain on the mechanism. Furthermore, it is an object of the invention to provide a cost-effective and structurally simple device for driving a door handle.

According to the invention, the object is achieved by the features of independent claim 1. Advantageous embodiments of the invention are specified in the dependent claims. It should be noted that the exemplary embodiments described below are not restrictive; rather, any variation of the features described in the description and the dependent claims is possible.

According to claim 1, the object of the invention is achieved in that a device for driving, preferably indirectly driving, a door handle of a motor vehicle for moving the door handle from a first position, in particular a rest position, into a second position, in particular an actuating position, is provided, having an electric drive, a gearbox downstream of the electric drive, and an output gear associated with the gearbox, wherein a movement can be introduced into the door handle by means of the output gear and wherein at least one gearbox part is assigned a means for position detection. By using a position detection device in a gearbox part, it is now possible to draw conclusions about the position of the drive, which enables the door handle to be moved reliably and in a controlled manner. The controller can be designed in such a way that the door handle can not only be moved quickly, but also the door handle can be gently braked when it reaches the end positions. This shows a further advantage of the inventive design of the device, viz., that the mechanism is only slightly stressed. By using the position detection means in the device for driving the door handle, a controlled and/or regulated movement of the door handle can be achieved. The mechanism does not necessarily have to be moved against a stop, which puts a lot of strain on the mechanism, but can, rather, be moved specifically into the rest position or actuating position.

If, according to the invention, reference is made to a door handle of a motor vehicle, this includes all handles that can be moved by means of a drive. This is not limited to a door handle, but can also include tailgates, covers, sliding doors, or hatches-in other words, wherever there are pivotable or movable components on the motor vehicle that are equipped with a retractable door handle. The drive does not have to drive the door handle directly; it is also possible for the drive to actuate a lever chain, wherein the lever chain then operates the door handle and/or opens and closes it.

In a first position, the door handle assumes a position in which the door handle preferably sits flush with the body. This allows an optimal aerodynamic surface to be achieved on the vehicle, and, at the same time, the door handle does not disturb the appearance of the vehicle. Rather, the door handle in the flush position can constitute a unit with the vehicle surface, so that one can also speak of a disappearing technology. The door handle is only moved out of the flush position when the operator wants to open the vehicle. For this purpose, the drive device moves the door handle into an extended second position, which can also be referred to as the actuating position. In any case, in the second position, the door handle protrudes from the surface at least in part, and/or protrudes from the surface in such a way that the operator can grasp and operate the door handle. The movement of the door handle is not limited to a linear movement, but can also be a pivoting movement or a combined movement of a linear, rotary, or pivoting movement. Depending upon the arrangement of the door handle, the door handle can be made available to the operator in the actuating position.

The electric drive used is preferably an electric motor and in particular a direct current motor. The electric drive is upstream of a gearbox, wherein the gearbox is not limited to one gear stage, but can comprise two, three, or more gear stages. Depending upon the desired force that is to be available to the door handle in order to move the door handle or to generate the fastest possible movement of the door handle, a different gear ratio may be advantageous. Ultimately, an output gear of the gearbox moves the door handle or directs the movement in the door handle.

In an advantageous embodiment variant of the invention, the means for position detection is at least partially integrated into a gearbox part. In the simplest case, the means for position detection can, for example, be a microswitch that interacts with a contour of a gearbox component. If more than one microswitch is installed, the microswitch can be used to detect different positions for controlling the movement of the door handle, thus ensuring controlled movement of the door handle. According to the invention, it is now proposed that a means for position detection be integrated into at least one gearbox part. By integrating the position detection device, a space-saving design can be realized, wherein the saving of space, especially in the region of the door handle, constitutes a decisive advantage. The interior of a door element is equipped with many components, units, and drives. Examples include a door module carrier, a window guide, a vehicle lock, a closing aid, etc. Due to the large number of components, the space required inside the door is limited. If, according to the invention, the means for position detection is integrated into a gearbox component, the device as a whole can be made smaller in design.

It has been found that it can be advantageous if the means for position detection is a magnet, wherein the magnet interacts with a sensor, in particular a Hall sensor. The use of a magnet is possible in a very simple way; in particular, the integration of a magnet into a gearbox component can be achieved with the simplest design means. The gear components are usually made of plastic, although a drive pinion, e.g., a worm gear, on the drive shaft of the electric motor can alternatively be made of a metallic material. Preferably, however, the other gearbox components are made of plastic. This makes it possible to place the magnet in a gearwheel of the gearbox in a very simple way. For example, in a gearbox component, a recess can be made into which the magnet can be inserted. The means of fastening the magnet can be a positive connection, a non-positive connection, or a material bond. In addition to the use of one magnet, it is of course also conceivable to integrate two or more magnets into one or more gearbox components in order to obtain further data about the gearbox position.

If the magnet is a diametrically magnetized magnet, a further design variant of the invention again results. A diametrically magnetized magnet allows an even more precise position detection of the gearbox, since the diametrically magnetized magnet allows at least two position values to be recorded by means of a sensor. This means that twice the number of signal values are available for position detection, even though only one magnet is used. However, the invention is not limited to a diametrically magnetized magnet; it is also conceivable that, for example, an axially arcuate magnetized magnet be used. What is essential to the invention is that the polarity of the magnet enables the movement of the gearbox components to be detected. For example, the movement can be detected using a Hall sensor.

In one embodiment variant of the invention, the magnet is integrated into the output gear of the gearbox. The output gear directly engages to actuate the door handle, wherein an output shaft on the output gear can be provided with a toothing that is directly associated with the actuation of the door handle. In any case, the door handle can be moved by means of the output gear as the last gearbox component and can be moved from the first position to the second position, and vice versa. Since the output gear interacts directly with the door handle or is connected to the door handle via a mechanism, a more precise value for the movement of the door handle can be detected on the output gear. The output gear therefore constitutes an advantageous position in the gearbox to reliably detect the movement of the door handle. The output gear can, for example, have a recess into which a cylindrical magnet can be inserted. As already explained above, the integration of the magnet into the output gear allows a space-saving arrangement of the magnet, and the cylindrical, i.e., symmetrical, design of the magnet also allows a structurally simple—due to its symmetrical form—design of the output gear.

According to the invention, the magnet works together with a circuit board associated with the device. The circuit board can be arranged in a housing of the device or can be connected to the housing of the device. In any case, a sensor means, in particular at least one Hall sensor, is arranged on the circuit board, and interacts with the magnet. Of course, it is also conceivable according to the invention to work with two or more Hall sensors, in order to generate a higher number of signals and thus achieve a more precise resolution in the context of the position detection of the door handle. Regardless of the inclusion of the detecting sensor, the circuit board is arranged in relation to the gearbox in such a way that the detection of the movement of the magnet is possible.

It may be advantageous and represent a variant embodiment of the invention if the device for driving the door handle is arranged in a separate housing. By arranging the device in a separate housing, a modular component is provided for driving the door handle. In other words, the device module can be available for different handles in different vehicles, since the device provides a means for driving the door handle and for detecting the position of the door handle. However, it is also conceivable that the device housing be designed in such a way that at least the circuit board can be mounted in the housing or on the housing, wherein it is also conceivable that the housing have an extension into which the circuit board for the position detection and/or the controller is inserted.

It may also be advantageous if the device housing is sealed, in particular by means of a laser. The device housing is preferably installed inside the door and preferably in the region of the door handle. The region of the door handle is exposed to environmental influences because the side windows of the vehicle are used here to provide a seal—but cannot completely seal the interior of the door element. This means that there is a possibility that, for example, rain or water can penetrate the door when the vehicle is cleaned, and reach the area of the device that drives the door handle. It is therefore important that the device is designed to be protected from moisture. The motor and the gearbox are located in the device housing, which is designed as a shell, for example. If the housing is then closed by means of a housing cover, the cover can be screwed on in order to achieve a sealed device housing. By using laser welding and in particular all-around laser welding, of the housing cover, on the one hand the use of a seal can be dispensed with, and on the other a sealed closure of the housing can be ensured. In addition, the laser connection of the housing and the housing cover provides a high-throughput process that advantageously supports series production.

If the gearbox has a total ratio of i=35 to i=65, preferably i=40 to i=50, and even more preferably i=45, this results in a variant embodiment of the invention. By setting a gear ratio, the operating speed of the door handle and the available force, i.e., the working torque of the device, can be set. For example, if a gearbox ratio of i=45, preferably i=46, is set, a working torque of 0.3 Nm can be made available at the output shaft. This makes it possible to generate torques which achieve a blocking torque of greater than 2 Nm at the stop, i.e., in a second position of the door handle, i.e., the actuating position. Depending upon the arrangement and design of the door handle and the desired speed, the speed and the force or torque on the door handle can be adjusted by setting the gear ratio.

As already stated above, an output shaft is assigned to the output gear, wherein the output shaft can advantageously be formed integrally with the output gear. The one-piece design of the output gear and output shaft allows a reliable output torque to be transmitted, and a device for driving the door handle can be created with the smallest possible number of components. If the magnet is integrated into the output gear, the output gear has a number of functions. On the one hand, the output gear is used for position detection, and on the other the output gear provides an output torque for moving the door handle. The one-piece construction offers an advantageous and structurally favorable option for operating the door handle.

In the following, the invention is explained in more detail with reference to the appended drawings using an exemplary embodiment. However, the principle applies that the exemplary embodiment does not limit the invention, but is merely an advantageous design. The features depicted can be implemented individually or in combination with further features of the description as well as what is claimed—individually or in combination.

In the drawings:

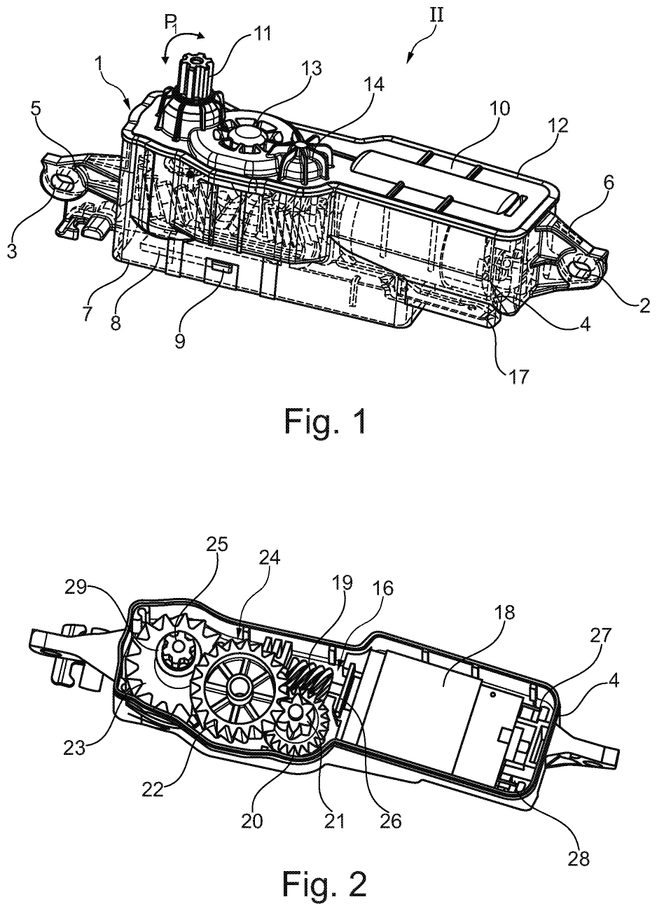

FIG. 1 is a three-dimensional view of a device for driving a door handle of a motor vehicle, with a closed housing and an output shaft protruding from the housing,

FIG. 2 is a plan view of the device according to FIG. 1 from the perspective of arrow II in FIG. 1, without the housing cover,

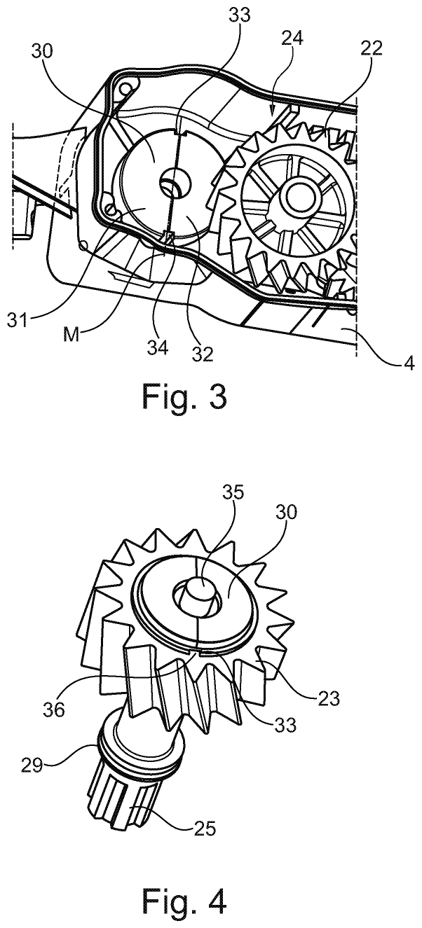

FIG. 3 is a detail view of the device without the output pinion and the output shaft, showing the position of the magnet in the device, and

FIG. 4 is the output gear with integrated magnet and integrally molded output shaft.

FIG. 1 is a three-dimensional view of a device 1 for driving a door handle of a motor vehicle. The device 1 can be fastened by means of screw openings 2, 3, to, for example, a door module carrier in the region of a door handle. For this purpose, extensions 5, 6 are integrally formed on the housing 4 so that a secure hold for the device 1 can be ensured. Furthermore, on the housing 4, a further receptacle 7 in the form of a downwardly open housing recess is formed, into which, for example, a (merely indicated) circuit board 8 can be inserted. The receptacle 7 can be closed with a housing cover (not shown), wherein the housing cover can snap into a clip connection 9.

In this exemplary embodiment, the device 1 is closed with a housing cover 10. An output shaft 11 protrudes from the housing cover 10, wherein the output shaft 11 serves to move the door handle. For this purpose, the output shaft can be driven back and forth in the direction of the arrow P1. The housing cover 10 is welded all around to the housing 4 by means of a laser seam. The housing cover 10 in turn has bearing points for the gearbox components, as well as a positive-fit receptacle 15 for the electric drive 16. Also visible in FIG. 1 is a plug socket 17 for electrically contacting the device 1.

FIG. 2 shows the device 1 from the direction of the arrow II, without the housing cover 10. Identical components are provided with the same reference signs. A worm 19 is driven by means of an electric motor 18, wherein the worm 19 meshes with a worm gear 20. The worm 19 and worm gear 20 form the first gear stage. A further gearwheel 21 is integrally formed on the worm gear 20 and meshes with a further gearwheel 22. The further gearwheel 22 in turn has a gearwheel (not visible), which is also connected to the further gearwheel 22. Thus, the gearwheel 22 is able to drive the output gear 23. The gearwheel 22 and the concealed, integrally connected gearwheel thus drive the output gear 23. As can be seen from the exemplary embodiment and the description, the gearbox 24 used here has three gear stages. The output shaft 25 is in turn connected to the output gear 23. In this exemplary embodiment, the output gear 23 and the output shaft 25 are made in one piece and as an injection-molded component. In this exemplary embodiment, only the worm 19 consists of a metallic material, while the other gearbox components 20, 21, 22, 23, 25 are made of plastic. Attention should also be drawn to the seal element 26, which can protect the electric motor 18 from the penetration of grease or oil.

If the electric motor 18 is energized via the electrical contacts 27, 28, the output gear 23 is actuated via the worm gear stages 19, 20 and the gearwheels 21, 22. The drive means connected to the output gear in the form of the output shaft 25 can then be used to move the door handle. In order to achieve, overall, a sealed output shaft 25, a sealing ring is provided on the output shaft 25, which, in conjunction with the housing cover 10, seals the gearbox 24 and the electric motor 18.

FIG. 3 now shows the housing 4 with a part of the gearbox 24. A magnet 30 can be seen, which is arranged as an integral part of the output gear 23 in the device 1 and in the gearbox 24. The magnet is diametrically divided along a center line M and has two magnetic poles 31, 32. The magnet 30 also has notches 33, 34 so that a positive connection can be established between the output gear 23 and the magnet 30. Thus, a positive connection can be established between the electromagnet 30 and the output gear 23, so that the magnet 30 can directly follow the movement of the output gear 23.

FIG. 4 shows the output gear 23 with the connected output shaft 25, wherein the magnet 30 integrated into the output gear 23 can also be seen. An extension 35 on the output gear 30 serves as a bearing point for the output gear 23. In this exemplary embodiment, the bearing point 35 is accommodated in the housing 4. As can also be clearly seen in FIG. 4, a raised portion on the output gear 23 interacts with the notch 33, so that a tongue-and-groove connection can be formed between the magnet 30 and the output gear 23. The cooperation between magnet 30 and output gear 23 enables the door handle to be positioned precisely, and the position of the output gear 23, the output shaft 25, and thus the door handle, can be determined by means of a Hall sensor arranged, for example, on the circuit board 8. This allows the door handle to be moved reliably and very precisely, so that the mechanism is subjected to as little stress as possible.

### LIST OF REFERENCE SIGNS

1 device
2, 3 screw opening
4 housing
5, 6, 35 extension
7, 15 receptacle
8 circuit board
9 clip connection
10 housing cover
11 output shaft
12 laser weld seam
13, 14 bearing points
16 electric drive
17 plug socket
18 electric motor
19 worm
20 worm gear
21, 22 gearwheel
23 output gear
24 gearbox
25 output shaft
26 seal element
27, 28 contact
29 sealing ring
30 magnet
31, 32 pole
33, 34 notch
36 elevation
P1 arrow
M center line

1. A device for driving a door handle of a motor vehicle, to move the door handle from a rest position into an actuating position, the device comprising:
an electric drive including a downstream portion, and
a gearbox including a plurality of gears,
wherein the gearbox is connected to the downstream portion of the electric drive,
wherein the plurality of gears includes an output gear,
wherein a movement is directed into the door handle by the output gear, and
wherein a position detection is assigned to the plurality of gears.

2. The device according to claim 1, wherein the position detection is at least partially integrated into the plurality of gears.

3. The device according to claim 1 further comprising a magnet and a sensor, wherein the position detection is achieved by the magnet, and wherein the magnet interacts with the sensor.

4. The device according to claim 3, wherein the magnet is a diametrically magnetized magnet.

5. The device according to claim 3, wherein the magnet is integrated into the output gear of the gearbox.

6. The device according to claim 3, further comprising a circuit board, wherein the magnet interacts with the circuit board.

7. The device according to claim 1, wherein the device is arranged in a separate housing.

8. The device according to claim 7, wherein the housing includes a housing cover, and wherein the housing cover is connected to a housing by a laser welding process.

9. The device according to claim 1, wherein the gearbox has a total gear ratio of i=35 to i=65.

10. The device according to claim 1, wherein the output gear includes an output shaft, and wherein the output shaft is formed integrally with the output gear.

11. The device according to claim 3, wherein the sensor is a Hall sensor.

12. The device according to claim 3, wherein the magnet is an axially arcuate magnetized magnet.

13. The device according to claim 1, wherein the gearbox has a total gear ratio of i=40 to i=50.

14. The device according to claim 1, wherein the gearbox has a total gear ratio of i=45.

15. The device according to claim 10, wherein the gearbox has a working torque of 0.3 Nm at the output shaft.

16. The device according to claim 7, wherein the housing is sealed such that the housing is protected from moisture.
